(19) United States
(12) Patent Application Publication
(10) Pub. No.: US 2006/0204740 A1
(43) Pub. Date: Sep. 14, 2006

(54) Foam article, especially trimming element for the interior of a motor vehicle, and method for producing the same

(75) Inventors: Manfred Rodewyk, Wuppertal (DE); Didier Weiss, Guerting (FR)

Correspondence Address: FOLEY & LARDNER LLP, 777 EAST WISCONSIN AVENUE, MILWAUKEE, WI, 53202-5306, US

(73) Assignee: JOHNSON CONTROLS TECHNOLOGY COMPANY

(21) Appl. No.: 10/544,469

(22) PCT Filed: Feb. 3, 2004
(86) PCT No.: PCT/EP04/00942

§ 371 Date: Aug. 4, 2005

(30) Foreign Application Priority Data
Feb. 4, 2003 (DE) 103 04 513.9

(51) Int. Cl. B32B 3/26; B32B 5/16

(52) U.S. Cl. 428/304.4; 428/323; 428/327

(57) ABSTRACT

A foam article comprising a base and a plastic sheet is disclosed. The base includes plastic particles. The plastic sheet encloses at least a portion of the base and comprises a material mixture having a first melting temperature and a second melting temperature. The second melting temperature of the plastic sheet is higher than the first melting temperature. The plastic particles of the base are configured to become agglomerated with one another at a third temperature that is greater than the first melting temperature and less than the second melting temperature. A method of making the foam article is also disclosed.

### CROSS REFERENCE TO RELATED APPLICATIONS

This application is the National Stage of International Application No. PCT/EP2004/000942, filed Feb. 3, 2004, which claims priority to German Application No. 10304513.9, filed Feb. 4, 2003, each of which are incorporated herein by reference in their entirety.

### FIELD OF THE INVENTION

The present invention relates to a foam article with a base made of plastic particles, which is enclosed at least in certain regions by a plastic sheet.

### BACKGROUND

The patent application EP 0591 553 B1 discloses a method of the generic type for producing a foam article provided with a skin on one side by means of a mold which comprises two mold halves which can be separated from each other.

After the opening of the mold, a possibly preformed, gas-impermeable skin made of plastic, for example of polypropylene, is placed in one of the mold halves. The skin has a thickness of at least 0.5 mm, but usually approximately 5 mm, and may be provided on the rear side with a layer of extruded flexible foam to improve the feel. On the inner side of the skin, or the laminate comprising the skin and the flexible foam, a bonding-improving adhesive is generally also applied.

After closing the mold, the cavity is filled with particles of preexpanded polypropylene with an average diameter of 0.1 to 10 mm, in particular 0.7 to 5 mm, which are heated up by supplying steam via the other mold half. The steam is at a temperature which lies below the melting temperature of the particles, so that their fusion is avoided. As a result of this procedure, the particle fill remains gas-impermeable and can be uniformly preheated by the steam. Once the particles have been subjected to a “murashi” (the applicant understands this term as meaning the dwell time possibly used for preheating), condensate is drained from the cavity. Subsequently, steam is fed once again into the mold, its temperature corresponding at least to the melting temperature of the already preheated particles, the particles partially fusing with one another. The article produced in this way can be removed from the mold once the mold halves are separated.

A disadvantage of this method is the long production cycles and the usually required use of adhesion promoters. Furthermore, molded articles of this type comprise material components which are integrally connected to one another, which are only suitable for recycling to a limited extent.

German Offenlegungsschrift DE 42 37 239 A1 discloses a foam article preferably formed as a sheet, for the production of which a core of expanded particles is produced in a first working step, the particles being obtained by grinding foam that is to be recycled. For this purpose, the cavity of a mold is filled with these particles and exposed to steam and air, whereby these particles agglomerate.

Subsequently, the mold cavity is enlarged by displacing slides, the core being held in a central position by positioning units. The space between the core and the mold wall is subsequently filled with fresh granular foam raw material. Subsequently, steam is once again fed into the mold, so that the fresh material forms a casing completely surrounding the core. In a final working step, the finished foam article can be removed from the mold. Polystyrene and polyolefins (polyethylene, polypropylene) come into consideration in particular as the material for producing the foam article.

Foam articles of this type, though lightweight, have adequate strength for many applications, but the quality of their surface is inadequate, since the structure of the agglomerated foam particles can be clearly seen.

It would be desireable to provide a molded article which can be produced with low production times, has a good surface quality and is unrestrictedly recyclable.

### SUMMARY

A foam article according to an exemplarly embodiment includes a plastic sheet consisting of a material mixture with at least a first melting temperature and a second melting temperature, which is higher than the first melting temperature, it being possible for the plastic particles to be agglomerated with one another at a temperature above the first melting temperature and below the second melting temperature of the plastic sheet.

This material composition provides the plastic sheet with adequate adhesion at the temperatures required for processing the plastic particles, by going above the first melting temperature, but, by remaining below the second melting temperature, it still has sufficient strength to have good thermoforming properties in spite of a small sheet thickness; and the surface structure of the agglomerated plastic particles is not visible through the plastic sheet, or only to an unobtrusive extent.

The material mixture can be obtained, for example, by mechanically mixing separately prepared homogeneous plastics.

Both the plastic particles and the plastic sheet preferably consist of partially crystalline plastics, the crystallite melting temperatures (KT1), (KT2), (KT3) corresponding to the melting temperatures mentioned (TS1, TS2, TS3). The crystallite structures respectively melt within a narrow temperature band, while the properties of the plastic sheet outside these temperature bands change only moderately. To this extent, fluctuations in the temperatures intended during the processing process have less of an effect on the product quality than in the case of amorphous plastics.

The material mixture of the plastic sheet has a similar material composition in terms of its proportions to the plastic particles and can be recycled together with the latter. Furthermore, by being formed in this way, the adhesion between the two components is facilitated.

A preferred material pairing, both with regard to recycling and with respect to use in a motor vehicle, comprises plastic particles of expanded polypropylene (EPP) and a plastic sheet comprising a mixture of polyethylene (PE), polypropylene (PP) and an olefinically based thermoplastic elastomer (TPO).

According to various exemplary and alternative embodiments, the plastic sheet may also be formed by a number of layers, with an unchanged small wall thickness, at least the layer facing the plastic particles being produced from the material mixture mentioned. In this case, for relatively little cost, one layer of the plastic sheet may be colored and/or provided with flatting agents, to improve the visual properties, while the inner layer continues to have adhesion with the plastic particles.

According to various exemplary and alternative embodiments, the thickness of the plastic sheet is, for example, 100 to 300 μm, preferably 150 to 250 μm, in particular approximately 200 μm. Such thin sheets reach the processing temperature in a short time when exposed to heated gas and increase the costs for the foam article only slightly.

The foam article may be given a particularly pleasing appearance if a texture is impressed on the outer side of the essentially smooth plastic sheet during the fusion with the plastic particles.

The benefits of foam articles of this type may be particularly striking if the foam article is given a flat form and the plastic sheet extends essentially over the sides of its surface area that are subsequently visible.

Such foam articles are especially suitable for use as a sun visor or door trim in motor vehicles.

According to an exemplarly embodiment, a foam article of this type is produced by the plastic sheet being placed in a multipart mold and the mold subsequently being filled with the plastic particles and heated gas, the temperature of the gas being higher than the first melting temperature, but lower than the second melting temperature, of the material mixture of the plastic sheet.

Water vapor, in particular wet steam, hot air or a mixture of the same preferably come into consideration as the gas, the gas likewise being able to serve for the pneumatic filling of the mold.

During placement in the mold, the plastic sheet is preferably clamped at the edges between its mold halves. During the pneumatic filling of the cavity, the plastic sheet then comes to lie against the surface of the mold. This process may possibly be assisted by applying a negative pressure on the opposite side. If required, it is also possible, by feeding in heated gas, to prestretch the plastic sheet after placement in the mold and before filling of the latter with the expandable plastic particles.

Given appropriate texturing of the cavity, the plastic sheet may also be impressed on the outside during the filling with the mixture of expandable plastic particles and heated gas, in order to improve the visual impression still further.

According to one exemplary embodiment, the gas supplied to the mold is removed at least partially via gas-permeable regions of the cavity of the mold that are not covered by the plastic sheet.

### BRIEF DESCRIPTION OF THE DRAWINGS

The figures provide a schematic representation of forms of the invention that are given by way of example and in which:

FIGS. 1a and 1b show a foam article according to one exemplary embodiment of the invention and an enlarged sectional representation.

FIGS. 2a and 2b show the h-T diagram of suitable plastics for the production of the plastic sheet and the plastic particles.

FIGS. 3a-3f show the method steps in the production of the foam article.

### DETAILED DESCRIPTION OF THE EXEMPLARY AND ALTERNATIVE EMBODIMENTS

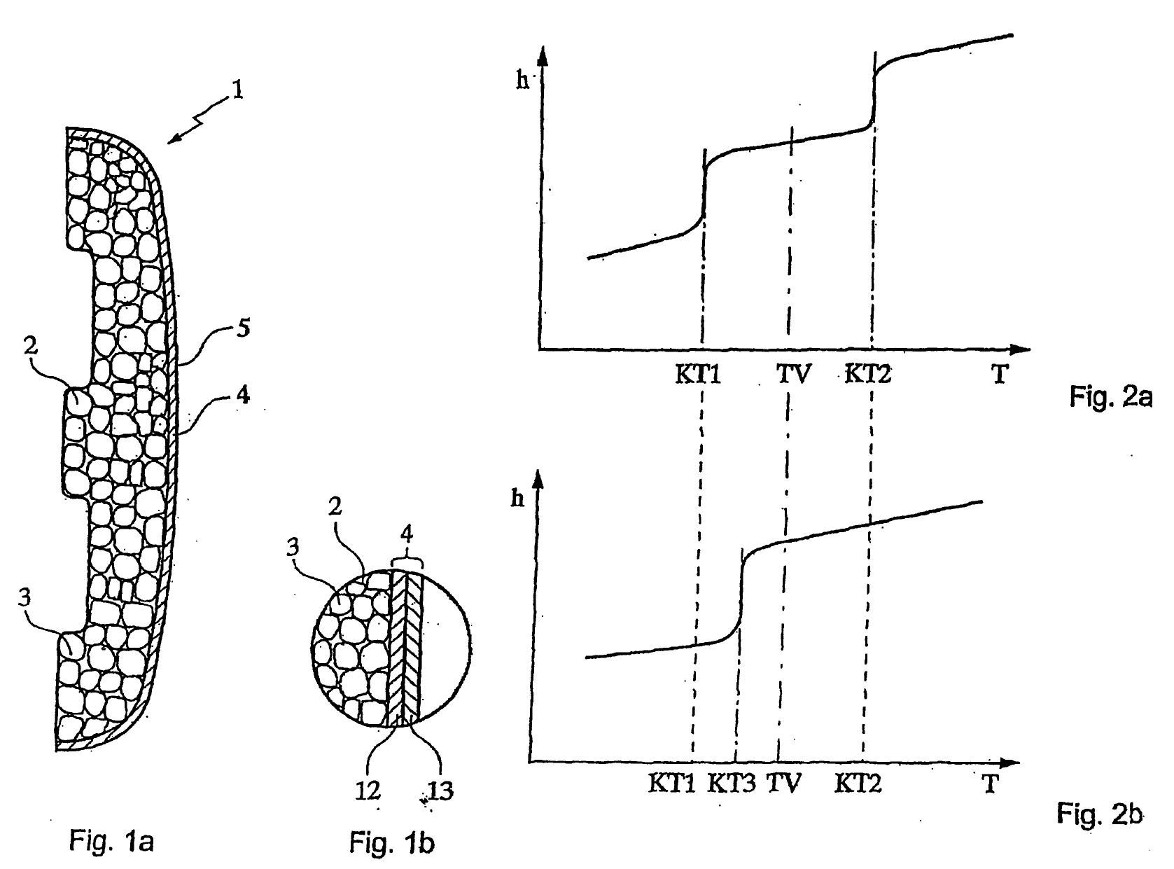

According to one exemplary embodiment, a foam article 1 represented in FIG. 1a is molded in a shell-like manner and subsequently forms one half of a two-part sun visor for a motor vehicle. It comprises a base 2 comprising agglomerated plastic particles 3 of expanded polypropylene (EPP), which may have an approximately spherical shape with a diameter of 3 to 4 mm.

One side of the surface area of the base 2 is covered with a plastic sheet 4 with a thickness of approximately 200 μm, which is integrally bonded to the base 2 without the addition of auxiliary agents (adhesion promoter, adhesive). The visible side 5 of the plastic sheet may be provided with a texture, for example a grain effect similar to leather.

According to one exemplary embodiment, the plastic sheet comprises a mixture of polyethylene (PE), polypropylene (PP) and an olefinically based thermoplastic elastomer (TPO), which on account of this material composition has two crystallite melting points KT1 and KT2, as revealed by the h-T diagram shown in FIG. 2a. When this mixture is heated by being exposed to a continuous stream of heat, the crystallite regions of the PE and of the TPO are initially melted at a temperature KT1 of approximately 125° C. This process is shown in the diagram by an abrupt increase in enthalpy with an essentially unchanged temperature. This behavior is typical of all partially crystalline plastics.

When further heat is supplied, the material reaches its second melting point at the temperature TS2 (or KT2) of approximately 160° C., at which the crystal structures of the PP are melted. This process is also manifested by an increase in enthalpy while the temperature remains virtually the same.

The plastic sheet 4 achieves adhesion when the temperature goes above KT1, but retains appreciable strength until KT2 is exceeded. This property is also relevant with regard to the later use of the foam article in the interior of a motor vehicle, so that good heat resistance of the foam article is maintained in spite of high temperatures from solar irradiation.

According to one exemplary embodiment, the plastic particles 3 consist of a PP random copolymer and have a crystallinity that is reduced in comparison with pure PP and a melting point KT3 of approximately 140° C., as can be seen from FIG. 2b.

The agglomeration of the plastic particles 3 takes place at a processing temperature TV of approximately 145° C., that is to say above their melting temperature KT3 and above the melting temperature KT1 of the plastic sheet 4. However, the temperature remains well below the second melting temperature KT2 of the plastic sheet, with the desired effects on its mechanical properties.

The chosen processing temperature TV may also allow filling of the mold cavity by wet steam at low pressures, so that the mold does not have to be of such a solid configuration as it does when higher temperatures are used.

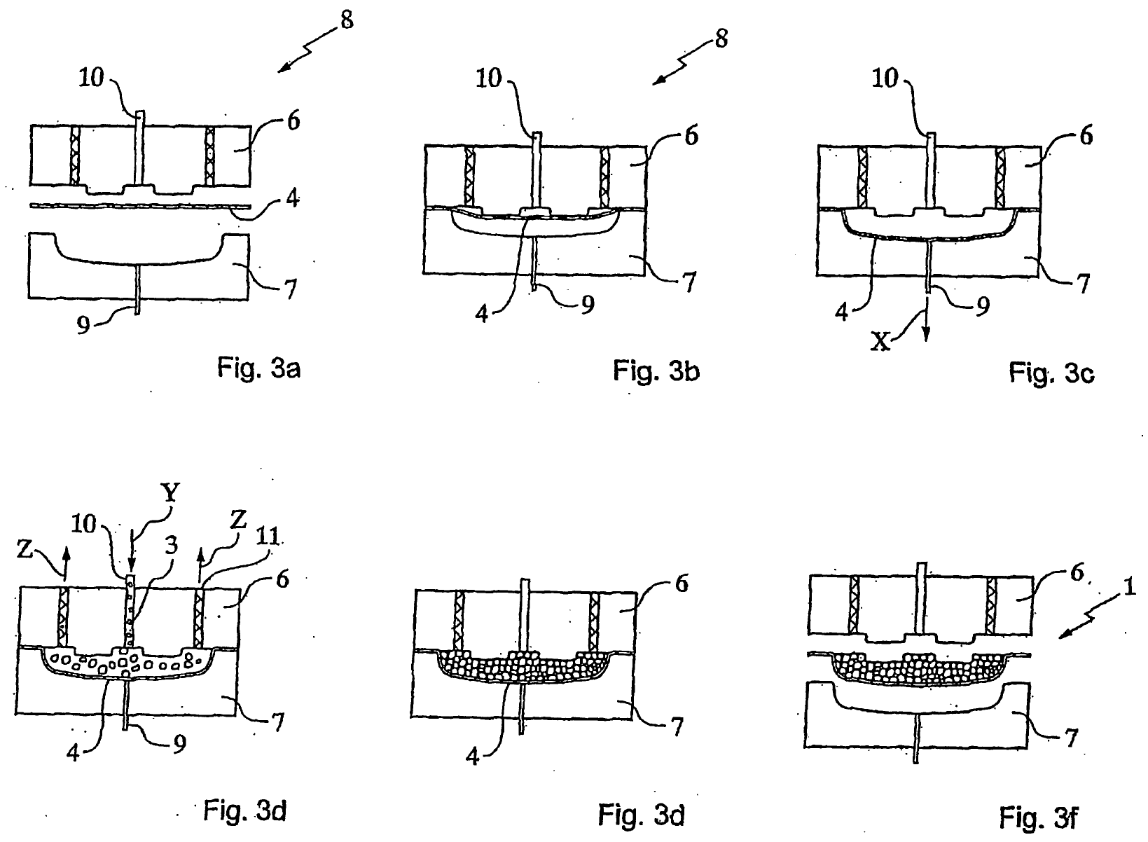

According to an exemplary embodiment, in the production of the foam article 1, firstly a plastic sheet 4 made of the material mixture mentioned is placed between the mold halves 6, 7 of the mold 8 (FIG. 3a) and held in a sealing manner after said mold halves have been closed (FIG. 3b).

Subsequently, a vacuum is applied (arrow X) to the lower mold half 7 via a negative-pressure line 9 that is assigned to the later visible side, whereby the plastic sheet 4 comes to lie against the textured wall of said mold half (FIG. 3c).

Subsequently, as can be seen from FIG. 3d, the cavity is filled via a charging line 10, which passes through the upper mold half 6, with a mixture of wet steam and preexpanded plastic particles 3 at a temperature below the second melting temperature TS2 or KT2 of the plastic sheet (arrow Y). The air previously in the cavity and the excess wet steam can in this case escape through gas-permeable regions 11 in the upper mold half 6 (arrow Z).

After the filling, the generally still expanding plastic particles 3 tend to fuse, on the one hand with one another and on the other hand with the plastic sheet 4, to form a molded article (FIG. 3e).

After the opening of the mold halves 6, 7 (FIG. 3f), the foam article 1 can be removed and passed on for edge trimming.

According to another exemplary embodiment, as represented in FIG. 1b, the plastic sheet (4) may have a multilayered structure with an inner layer (12) and an outer layer (13), although at least the inner layer (12), facing the base, is produced from the material mixture mentioned comprising PE, PP and TPO.

List of Designations

1 foam article
2 base
3 plastic particles
4 plastic sheet
5 visible side
6,7 mold halves
8 mold
9 negative-pressure line
10 charging line
11 gas-permeable region
12,13 layer (of the plastic sheet)

1-19. (canceled)

20. A foam article comprising:
a base including plastic particles; and
a plastic sheet enclosing at least a portion of the base, the plastic sheet comprising a material mixture having a first melting temperature and a second melting temperature, the second melting temperature being higher than the first melting temperature;
wherein the plastic particles of the base are configured to become agglomerated with one another at a third temperature greater than the first melting temperature and less than the second melting temperature.

21. The foam article of claim 20, wherein the plastic particles and the plastic sheet comprise partially crystalline plastics, the partially crystalline plastics of each of the plastic particles and the plastic sheet having at least one of a first crystallite melting temperature, a second crystallite melting temperature, and a third crystallite melting temperature.

22. The foam article of claim 21, wherein the first crystallite melting temperature corresponds to the first melting temperature, the second crystallite melting temperature corresponds to the second melting temperature, and the third crystallite melting temperature corresponds to the third melting temperature.

23. The foam article of claim 20, wherein the material composition proportions of the plastic sheet are similar to the material composition proportions of the plastic particles.

24. The foam article of claim 20, wherein the plastic particles are expanded polypropylene.

25. The foam article of claim 20, wherein the plastic sheet is a mixture of polyethylene, polypropylene, and an olefinically based thermoplastic elastomer.

26. The foam article of claim 20, wherein the plastic sheet comprises a first layer facing the base and a second layer.

27. The foam article of claim 26, wherein at least the first layer comprises a mixture of polyethylene, polypropylene, and an olefinically based thermoplastic elastomer.

28. The foam article of claim 27, wherein at least one of the first layer and the second layer is colored.

29. The foam article of claim 27, wherein at least one of the first layer and the second layer comprises flatting agents.

30. The foam article of claim 20, wherein the thickness of the plastic sheet is between 100 μm and 300 μm.

31. The foam article of claim 30, wherein the thickness of the plastic sheet is between 150 μm and 250 μm.

32. The foam article of claim 31, wherein the thickness of the plastic sheet is approximately 200 μm.

33. The foam article of claim 20, wherein an outer surface of the plastic sheet is textured.

34. The foam article of claim 20, wherein the base is substantially flat and includes at least two sides and wherein the plastic sheet extends over at least one of the at least two sides.

35. The foam article of claim 20, wherein the foam article is-an interior trim component for a motor vehicle.

36. The foam article of claim 35, wherein the foam article is one of a sun visor and a door trim.

37. A method of producing a foam article comprising the steps of:
providing a mold;
placing a plastic sheet in the mold the plastic sheet comprising a material mixture having a first melting temperature and a second melting temperature, the second melting temperature being higher than the first melting temperature; and
filling the mold with plastic particles and a first heated gas, the temperature of the first heated gas being greater than the first melting temperature and lower than the second melting temperature.

38. The method of claim 37, wherein the first heated gas is one of water vapor, hot air, and a mixture of water vapor and hot air.

39. The method of claim 38, wherein the first heated gas is one of wet steam, hot air, and a mixture of wet steam and hot air.

40. The method of claim 37, further comprising the step of conveying the plastic particles into the mold using the first heated gas.

41. The method of claim 37, wherein the mold comprises a first half and a second half.

42. The method of claim 41, further comprising the step of placing the plastic sheet between the first half of the mold and the second half of the mold.

43. The method of claim 42, further comprising the step of clamping the edges of the plastic sheet between the first half and the second half of the mold.

44. The method of claim 37, further comprising the step of applying negative pressure to move the plastic sheet against an inner wall of the mold.

45. The method of claim 37, further comprising the step of feeding a second heated gas into the mold to prestretch the plastic sheet.

46. The method of claim 45, wherein the first heated gas is the same as the second heated gas.

47. The method of claim 45, wherein the step of feeding the second heated gas into the mold is performed before the step of filling the mold with the plastic particles and the first heated gas.

48. The method of claim 37, wherein the mold includes a cavity surface and wherein at least a portion of the cavity surface is textured.

49. The method of claim 48, further comprising the step of pressing the plastic sheet against the textured portion of the cavity surface to provide a textured surface on the plastic sheet.

50. The method of claim 37, wherein the mold includes at least one gas-permeable region configured to allow gas to escape from the mold.

51. The method of claim 50, further comprising the step of removing at least one of the first heated gas and the second heated gas from the mold through the at least one gas-permeable region of the mold.
